(19) United States
(12) Patent Application Publication
(10) Pub. No.: US 2023/0289561 A1
(43) Pub. Date: Sep. 14, 2023

(54) COMPUTER-IMPLEMENTED METHOD FOR THE GENERATION OF A MATHEMATICAL MODEL WITH REDUCED COMPUTATIONAL COMPLEXITY

(71) Applicant: POLITECNICO DI MILANO, Milano (IT)

(72) Inventors: Luca DEDE', Milano (IT); Alfio QUARTERONI, Milano (IT); Francesco REGAZZONI, Milano (IT)

(73) Assignee: POLITECNICO DI MILANO, Milano (IT)

(21) Appl. No.: 18/012,737

(22) PCT Filed: Jun. 25, 2021
(86) PCT No.: PCT/IB2021/055646

§ 371 Date: Dec. 23, 2022

(30) Foreign Application Priority Data
Jun. 29, 2020 (IT) 102020000015619

(51) Int. Cl. G06N 3/045; G06N 3/08

(52) U.S. Cl. CPC G06N 3/045; G06N 3/08

(57) ABSTRACT

A computer-implemented method for the generation of a mathematical model with reduced computational complexity comprises at least the following steps: receiving at input a dataset comprising a plurality of input-output pairs relating to a phenomenon under consideration; receiving at input a plurality of functions relating to principles governing the phenomenon under consideration; determining a first term starting from the dataset comprising a plurality of input-output pairs; determining a second term starting from the functions relating to principles; generating a mathematical model by means of at least one artificial neural network trained on the basis of a loss function obtained starting from the first term and the second term.

### TECHNICAL FIELD

The present invention relates to a computer-implemented method for the generation of a mathematical model with reduced computational complexity, in particular for the generation of a surrogate mathematical model with reduced computational complexity compared to an existing mathematical model.

### BACKGROUND ART

It is well known that by means of mathematical models it is possible to describe various phenomena (including natural processes, biological systems, management, control and optimization of industrial plants, social dynamics, risk assessment of financial transactions, etc.) using differential equations of an evolutionary (time-dependent) type.

More specifically, with reference to the dynamic systems, mathematical time-dependent differential models are known, i.e. of an evolutionary type, which describe the evolution over time of variables of interest. The dynamics of the variables of interest can be possibly influenced by other variables, called input variables, which can be constant (in which case they are more properly called parameters), or they can also be time-dependent (in which case we speak of forcing terms). The dynamics of the variables of interest can also be influenced by the initial conditions of the system, which can be included in the parameters of the model.

The aforementioned mathematical models serve various purposes, including that of understanding the studied phenomenon and that of predicting the trend over time relating to amount of interest, through the numerical solution (i.e. by computer) of these differential equations, with obvious repercussions of industrial, financial, health, etc. interest (depending on the sphere in which the described phenomenon is located).

Mathematical models are usually developed and calibrated by people who are experts in the phenomenon in question; this requires a deep understanding of the phenomenon itself and a translation of the first (physical) principles governing it into mathematical terms. This approach is usually referred to as the white-box approach.

An alternative approach is instead to automate the construction of mathematical models through Machine Learning algorithms which, by using only experimental data, learn or subrogate models written in the form of mathematical equations without having to resort to first (physical) principles. This approach is generally referred to as the black-box approach.

Known approaches, however, do have limitations.

In particular, it is known that a white-box approach may be subject to limitations due to gaps in knowledge of the phenomenon under consideration (e.g. epistemic uncertainties).

Furthermore, the white-box approach requires long development and calibration times.

On the other hand, a black-box approach is subject to inevitable errors and uncertainties in the dataset (e.g. measurement, bias).

Moreover, in many cases, in the case of both black-box and white-box approaches, the need exists to subrogate mathematical models which have high computational costs and/or are of relevant parametric complexity.

### DESCRIPTION OF THE INVENTION

The main aim of the present invention is to devise a computer-implemented method for the generation of a mathematical model with reduced computational complexity compared to an existing mathematical model.

Another object of the present invention is to devise a computer-implemented method for the generation of a mathematical model with reduced computational complexity which allows exploiting knowledge of the phenomenon, while at the same time filling any gaps in such knowledge.

Another object of the present invention is to devise a computer-implemented method for the generation of a mathematical model with reduced computational complexity which allows correcting unavoidable errors and uncertainties of the dataset.

The objects set out above are achieved by the present computer-implemented method for the generation of a mathematical model with reduced computational complexity according to the characteristics of claim 1.

### BRIEF DESCRIPTION OF THE DRAWINGS

Other characteristics and advantages of the present invention will become more apparent from the description of a preferred, but not exclusive, embodiment of a computer-implemented method for the generation of a mathematical model with reduced computational complexity, illustrated by way of an indicative, yet nonlimiting example, in the accompanying tables of drawings in which:

FIG. 1 and FIG. 2 are general functional diagrams of the computer-implemented method according to the invention.

### EMBODIMENTS OF THE INVENTION

With particular reference to such figures, reference letter M globally indicates a computer-implemented method for the generation of a mathematical model with reduced computational complexity compared to an existing mathematical model.

The computer-implemented method M according to the invention allows for the automated construction of a mathematical model describing a time-dependent phenomenon by combining information coming from experimental data with information from a priori knowledge of the (physical) phenomenon under consideration.

Therefore, the computer-implemented method M according to the invention proposes a grey-box approach, which makes it possible to exploit the a priori knowledge of the phenomenon to be modelled (such as the first physical principles on which it is based) and, at the same time, an available dataset related to the phenomenon.

The advantage of the proposed grey-box approach is to exploit the knowledge of the phenomenon, but at the same time to fill any gaps in this knowledge (e.g. epistemic uncertainties) through Machine Learning algorithms that exploit the available dataset. On the other hand, the grey-box approach allows the correction of unavoidable errors and uncertainties of the dataset (measurement, bias, ...) on the basis of first principles that derive from the a priori knowledge of the phenomenon under consideration.

Moreover, the computer-implemented method M according to the invention can be applied in Model Order Reduction situations where it is necessary to subrogate mathematical models having high computational costs and/or of considerable parametric complexity.

In particular, starting from a computationally expensive mathematical model which makes it possible to describe a certain phenomenon (such model is called high-fidelity model, or HF) and starting from a dataset which takes the place of the experimental data, generated through the numerical solution of the HF model, the computer-implemented method M according to the invention is able to build, according to the grey-box approach, i.e., in combination with the a priori knowledge of the HF model, a new mathematical model of reduced dimensions and, therefore, computationally less expensive.

In particular, the computer-implemented method M for the generation of a surrogate mathematical model with reduced computational complexity compared to an existing mathematical model, comprises at least the following steps:
receiving at input a dataset comprising a plurality of input-output pairs relating to a phenomenon (e.g. a physical phenomenon) under consideration (step 1);
receiving at input a plurality of functions J_{phys},ᵢ relating to principles (e.g. physical principles) 1, ..., Nₚ governing the phenomenon under consideration (step 2);
determining a first term J_{data} starting from the dataset comprising a plurality of input-output pairs (step 3);
determining a second term J_{phys} starting from the functions J_{phys},ᵢ relating to principles 1, ..., Nₚ (step 4);
generating a mathematical model by means of at least one artificial neural network (f, g) trained on the basis of a loss function obtained starting from the weight average of the first term J_{data} and of the second term J_{phys} (step 5).

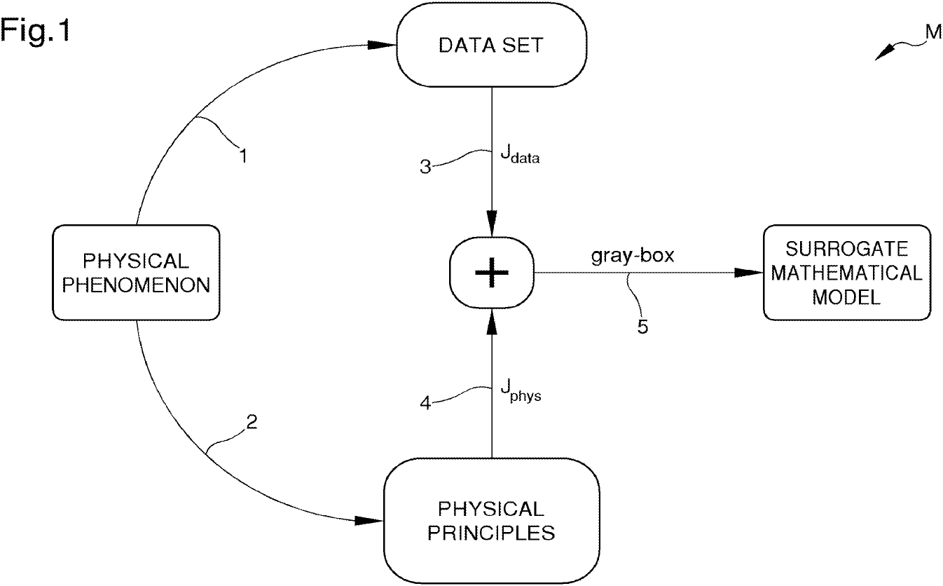

Therefore, the computer-implemented method M according to the invention makes it possible to generate a surrogate mathematical model for a given physical phenomenon using information of a different nature, but in any case originating and/or related to the physical phenomenon itself, as shown in FIG. 1.

First of all, a dataset of input-output pairs related to the phenomenon under consideration is used. This dataset can be made up of experimental data, or (in the case where the application is that of model order reduction) of data produced by an existing mathematical model (specifically an HF model).

According to a preferred embodiment, the plurality of input-output pairs of the dataset is produced by the existing mathematical model.

Furthermore, the computer-implemented method M according to the invention exploits the a priori knowledge of functions J_{phys},ᵢ which translate the first principles Nₚ governing the phenomenon under consideration (such as physical principles, conservation laws, known properties of the phenomenon).

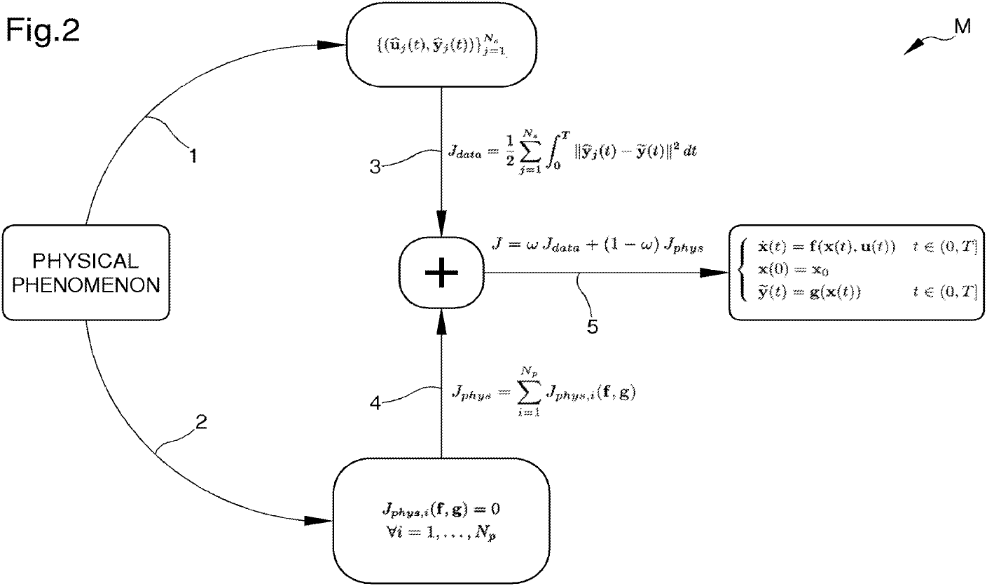

As shown in FIG. 2, the dataset comprising a plurality of input-output pairs is defined by the following formula:

$$\left({\hat{\text{u}}}_{\text{j}} \left(\text{t}\right) \text{,} {\hat{\text{y}}}_{\text{j}} \left(\text{t}\right)\right) \text{,} \text{t} ∈ \left[{\text{0,T}}_{\text{j}}\right]$$

by j = 1, ..., Ns;
where u(t) is a time-dependent input signal;
where y(t) is a time-dependent output signal;
where Ns is the number of input-output pairs;
where Tⱼ represents the duration of the j-th pair.

More precisely, it is assumed that the phenomenon under consideration is of a time-dependent type and that its evolution depends on a collection of inputs u(t), consisting of a time-dependent signal (generally with vector values).

It is also assumed that the phenomenon is characterized by a collection of time-dependent output signals y(t), also generally vector values, representing a collection of observable values or variables of interest.

Therefore, the dataset can be written as a collection of pairs of:

$$\left({\hat{\text{u}}}_{j} \left(t\right) \text{,} {\hat{\text{y}}}_{j} \left(t\right)\right) \text{,} t ∈ \left[\text{0,} {T}_{j}\right]$$

by j = 1, ..., Ns, where Ns is the number of input-output pairs, where Tⱼ represents the duration of the j-th pair.

In particular, with reference to a preferred embodiment of the method M, the generated surrogate mathematical model is defined by the following formula:

$$\left\{\begin{matrix}\frac{d x}{d t} = \text{f} \left(x \left(t\right) , u \left(t\right)\right) t ∈ \left(0 , T\right) \\ x \left(0\right) = {x}_{0} \\ \tilde{y} \left(t\right) = \text{g} \left(x \left(t\right)\right) t ∈ \left(0 , T\right)\end{matrix}\right)$$

where f represents a first artificial neural network (ANN);
g represents said second artificial neural network;
x(t) is a vector with Nₓ elements, representing the internal state of the system (the number of states Nₓ may be established a priori);
u(t) is a time-dependent input signal;
ỹ(t) is a time-dependent output signal predicted by the surrogate mathematical model.

In particular, the first artificial neural network f and the second artificial neural network g are trained on the basis of a loss function composed of the weighted average of the first term J_{data} and of the second term J_{phys}, as described here below and as shown in FIG. 2.

According to a preferred embodiment, the first term J_{data}, of the black-box type, is composed of the Euclidean standard distance between the plurality of time-dependent outputs (ŷⱼ (t)) belonging to the dataset and the corresponding outputs (ŷⱼ(t)) predicted by the surrogate model.

In particular, the first term J_{data} is defined by the following formula:

$${J}_{d a t a} = \frac{1}{2} {\sum }_{j = 1}^{{N}_{S}} {\int }_{0}^{{T}_{j}} {\left‖{\hat{y}}_{j} \left(t\right) - {\tilde{y}}_{j} \left(t\right)\right‖}^{2} d t$$

where J_{data} is the first term;
ŷj (t) are the outputs belonging to the dataset;
ŷⱼ(t) are the outputs predicted by the surrogate mathematical model;
Ns is the number of input-output pairs;
Tⱼ represents the duration of the j-th pair.

The second term J_{phys}, on the other hand, of the white-box type, is composed of the sum of the functions J_{phys},_{I}, which benefit the consistent models with the priori knowledge about the phenomenon under consideration, written in the form J_{phys},ᵢ(f, g) = 0, where i = 1, ..., Nₚ represent said different physical principles known a priori.

In particular, the second term J_{phys} is defined by the following formula:

$${J}_{p h y s} = \frac{1}{2} {\sum }_{j = 1}^{{N}_{P}} {J}_{p h y s , i} \left(\text{f} , \text{g}\right)$$

where J_{phys} is the second term;
J_{phys},ᵢ(f, g) represents one of the aforementioned functions;
f is the first artificial neural network;
g is the second artificial neural network;
1, ..., Nₚ represent the physical principles governing the physical phenomenon under consideration.

In particular, J_{phys},ᵢ are positive or nil value functions.

The second term J_{phys} of the white-box type, allows informing, in a very versatile way, the artificial neural network about the a priori knowledge which one has regarding the mathematical model one wishes to learn.

Below, by way of example, is a non-exhaustive list of possible information which can be exploited for this purpose, and how this can be implemented through the second term J_{phys} .

As a first example, suppose we know that the initial state represents a state of equilibrium, when the system for which we want to build a mathematical model is stressed with the input u₀. Such information can be expressed through the relation ||f(x₀, u₀)||=0.

Such information can derive from the knowledge of the starting HF mathematical model (if one is doing Model Order Reduction), or from the physical knowledge of the phenomenon (for instance, for a biological system, the ground-state could be known).

Therefore, the following loss term fulfils the purpose of informing the artificial neural network of this a priori knowledge:

$${J}_{p h y s , i} = {\left‖f \left({x}_{0} , {u}_{0}\right)\right‖}^{2}$$

inasmuch as it gives an advantage to the mathematical models whereby the term ||f(x₀, u₀)|| is close to 0 compared to the models whereby such term is far from 0. As second example, it can be observed that many physical systems are characterized by laws of conservation, expressed as W(y(t)) = W(y(0)) for each t ≥ 0, where W is a suitable function of the state y.

In such cases, making sure the mathematical model one builds is consistent with these conservation laws would greatly increase the quality and reliability thereof.

To derive a penalty term that achieves this purpose, we note that the relation

$$\frac{d}{d t} W \left(y \left(t\right)\right) = 0$$

implies:

$$\begin{matrix}0 = \frac{d}{d t} W \left(g \left(x \left(t\right)\right)\right) = ∇ W \left(g \left(x \left(t\right)\right)\right) ⋅ ∇ g \left(x \left(t\right)\right) \frac{d}{d t} x \left(t\right) \\ = ∇ W \left(g \left(x \left(t\right)\right)\right) ⋅ ∇ g \left(\left(x \left(t\right)\right)\right) f \left(x \left(t\right) , u \left(t\right)\right)\end{matrix}$$

Therefore, making sure that the expression given by the last line is identically nil for each possible state x and input u would guarantee the consistency of the generated mathematical model with the conservation law.

To this end, the computer-implemented method M according to the invention comprises at least one step of introducing a penalty term, defined by the following formula:

$${J}_{p h y s , i} = {\sum }_{h = 1}^{{N}_{h}} {\left|∇ W \left(g \left({x}_{h}\right)\right) ⋅ ∇ g \left({x}_{h}\right) f \left({x}_{h} , {u}_{h}\right)\right|}^{2}$$

where (xₕ, uₕ) are a collection of Nₕ points covering in a fairly packed way the space of the inputs-states (built e.g. by means of Monte Carlo sampling or Latin Hypercube sampling).

As third example, it is assumed that the phenomenon under consideration is intrinsically periodic (such as e.g. the cardiac dynamics of a patient). In this case there is reason to assume that by the end of a cycle, the state of the system x(t) will have returned to its initial value x(0) = x₀.

In other cases, although the phenomenon under consideration is not periodic, it may happen that in some experiments the system under consideration returns to its initial condition.

This may be known either from knowledge of the HF mathematical model which generated the experiment or on the basis of physical considerations.

In general, it is assumed that for the experiments, the index of which belongs to the set J_{c}, the condition x(Tⱼ) = x₀ is to be imposed.

In such a case, the compueter-implemented method according to the invention comprises at least one step of introducing a penalty term defined by the following formula:

$${J}_{p h y s , i} = {\sum }_{j ∈ {J}_{c}} \frac{{\left‖{x}_{j} \left({T}_{j}\right) - {x}_{0}\right‖}^{2}}{\frac{1}{{T}_{j}} {\int }_{0}^{{T}_{j}} {\left‖{x}_{j} \left(t\right)\right‖}^{2} d t}$$

where normalization compared to the history of the state xⱼ(t) serves to improve the stability of the optimization.

Notice how J_{phys},ᵢ is not explicitly expressed as a function of f and g, but of the time history of the state x. Nevertheless, the latter is univocally determined by the function f; the dependence of J_{phys},ᵢ on f is therefore given in implicit form through the equation of state

$$\left\{\begin{matrix}\frac{d x}{d t} = \text{f} \left(x \left(t\right) , u \left(t\right)\right) t ∈ \left(0 , T\right) \\ x \left(0\right) = {x}_{0} \\ \tilde{y} \left(t\right) = \text{g} \left(x \left(t\right)\right) t ∈ \left(0 , T\right)\end{matrix}\right)$$

As a fourth and last example, we assume instead that the response of the physical system being studied is symmetrical with respect to the input u(t), i.e. f(x, u) = f(x, -u) for each value of x and u. This information can be introduced in the training.

In this case, the computer-implemented method comprises at least one step of introduction of the following term:

$${J}_{p h y s , i} = {\sum }_{h = 1}^{{N}_{h}} {\left‖\text{f} \left({x}_{h} , {u}_{h}\right) - \text{f} \left({x}_{h} , - {u}_{h}\right)\right‖}^{2}$$

where (xₕ, uₕ) are a collection of Nₕ points covering in a fairly packed way the space of the inputs-states.

A variant of the previous case is the situation whereby the response is symmetrical only with respect to some elements of the input (e.g., only to the first input variable). In this case, the loss term introduced above can be generalized.

In particular, in this case, the computer-implemented method comprises at least a step of introduction of the following term:

$${J}_{p h y s , i} = {\sum }_{h = 1}^{{N}_{h}} {\left‖\text{f} \left({{x}^{′}}_{h} , {{u}^{′}}_{h}\right) - \text{f} \left({x}_{h} , {{u}^{″}}_{h}\right)\right‖}^{2}$$

where the inputs

$${{u}^{′}}_{h}$$

and

$${{u}^{″}}_{h}$$

are such as to satisfy the relation

$${{u}^{′}}_{h} ⋅ {e}_{1} = - {{u}^{″}}_{h} ⋅ {e}_{1}$$

for each h = 1, ...,Nₕ (e₁ being = (1, 0, ..., 0)^{T} the first element of the canonic base).

Note that the strategy proposed herein can be easily generalized to other known properties of functional dependence on state or input.

The a priori knowledge introduced by the terms J_{phys},ᵢ in some cases can be introduced in a strong way, i.e. making it automatically satisfied instead of being imposed through penalty terms. This can be achieved by appropriately manipulating the architecture of artificial neural networks f and g.

Two examples are described below, taking up cases considered above.

In particular, the condition ||f(x₀, u₀)||=0 can be realized by removing the last layer of bias from the artificial neural network f and replacing it with the vector given by the application of the artificial neural network f to the input (x₀, u₀), after changing its sign.

In particular, the computer-implemented method in this case comprises the definition of an intermediate neural network f̅ and the definition of the first artificial neural network f according to the following formula:

$$\text{f} \left(\text{x,} \text{u}\right) = \hat{\text{f}} \left(\text{x,} \text{u}\right) - \hat{\text{f}} \left({\text{x}}_{\text{0}} \text{,} {\text{u}}_{\text{0}}\right)$$

This way, the condition ||f(x₀, u₀)||=0 is satisfied by construction.

The condition f (x, u) = f (x, -u) can also be set by manipulating the architecture of the artificial neural network f. More specifically, suffice it to add a layer before the input of u, which applies the operation abs() (absolute value) to each element of u.

In particular, the computer-implemented method in this case comprises the definition of an intermediate neural network f̅ and the definition of the first artificial neural network f according to the following formula:

$$\text{f} \left(\text{x,} \text{u}\right) = \hat{\text{f}} \left(\text{x} , \text{abs} \left(\text{u}\right)\right)$$

In this case as well, the condition f (x, u) = f (x,-u) is automatically satisfied. With reference to the training of the artificial neural networks f and g, the two unknown functions f (x; u) and g(x) are represented by the respective artificial neural networks.

It is therefore possible to emphasize the dependence of these functions on the parameters of artificial neural networks by writing the two functions as f(x, u; η) and g(x; y), where η and y are vectors that collect the values of the parameters of the two networks (i.e., the weights and bias of the networks).

In particular, according to a preferred embodiment of the method M, the step 5 of generating a mathematical model comprises at least one training step of the artificial neural networks f, g carried out according to the following optimization problem:

$$\left({η}^{∗} , {γ}^{∗}\right) = {arg min}_{η , γ} \left({J}_{d a t a} + {J}_{p h y s}\right)$$

where η and y are vectors that collect the values of the parameters of the two networks f, g, subject to the constraint given by:

$$\left\{\begin{matrix}\frac{d {x}_{j}}{d t} = f \left({x}_{j} \left(t\right) , {u}_{j} \left(t\right) ; η\right) & j = 1 , … , {N}_{S} , t ∈ \left(0 , {T}_{j}\right) \\ {x}_{j} \left(0\right) = {x}_{0} & j = 1 , … , {N}_{S} \\ {\tilde{y}}_{j} \left(t\right) = g \left({x}_{j} \left(t\right) ; γ\right) & j = 1 , … , {N}_{S} , t ∈ \left(0 , {T}_{j}\right)\end{matrix}\right)$$

The architecture of the artificial neural networks f and g is established a priori, on the basis of how rich one wants the space of functions within which the solution is sought.

A possible option is to establish g a priori, and carry out the training only with respect to f (i.e. the only unknown remains η).

For the purpose of numerically solving the optimization problem defined above, the differential equations (just like the integrals present in the loss functions J_{data} and J_{phys}) must be suitably discretized. Preferably, with regard to the discretization of the differential equations, the method according to the invention uses explicit methods, such as the explicit Euler method, in order to achieve the best trade-off between accuracy and computational efficiency.

Preferably, the integrals present in the loss functions are instead approximated by means of numerical quadrature formulas such as the trapezoid method.

After both the equations and the loss function are discretized, the problem is configured as a discrete optimization problem. In fact, even the variables with respect to which we minimize (i.e., η and y) are discrete variables. Therefore, the method according to the invention may comprise the application of generic optimization algorithms and software tools. In particular, automatic differentiation (AD) tools, which are typically available in machine learning software packages wherein the artificial neural networks are implemented, can be applied for calculating gradients.

As an alternative to automatic differentiation, an efficient way to calculate the gradients of the loss function with respect to the unknowns η and y is to use the Lagrange multiplier technique.

### Application Example

The following is a successful example of application of the invention to a case of concrete interest.

The example given concerns the order reduction of a biophysical model of great complexity (the numerical resolution of which involves a relatively high computational cost).

The model describes the biochemistry of cardiac sarcomeres, the fundamental contractile units of the cardiac muscle. This model allows predicting through numerical simulation the amount of active force that cardiomyocytes (the muscle cells) produce in response to a chemical input (calcium ions) and based on the feedback of the effect that this force has on the tissue at the macro-scale (i.e. the local strain, or deformation, of the tissue). Specifically, the model can be written as follows:

$$\left\{\begin{matrix}\frac{d X}{d t} = \text{F} \left(\text{X} \left(t\right) , \text{u} \left(t\right)\right) t ∈ \left(0 , T\right) \\ \text{X} \left(0\right) = {\text{X}}_{0} \\ P \left(t\right) = \text{G} \left(\text{X} \left(t\right)\right) t ∈ \left(0 , T\right)\end{matrix}\right)$$

where the input (time-dependent) u(t) = ([Ca²⁺]ᵢ(t),SL(t))^{T} is given by the intracellular concentration of calcium ions [Ca²⁺]ᵢ(t) and by the elongation of the sarcomere SL(t). The output P(t) represents the normalized force (P=0 corresponds to no generated force, P=1 corresponds to maximum force). The internal state of the system X(t) is a vector containing 2176 elements altogether, which describe the internal state of the main proteins of the myofilaments making up the sarcomere. The computational cost for the simulation of 1 s of physical time with the model is about 13 s of computational time.

The reduction of the computational cost associated with the resolution of the model is of great practical interest in the context of computational medicine. In fact, such models can be used to make simulations of the dynamics of the entire heart (or one of its chambers, such as one of the ventricles).

However, for this purpose the sub-cellular force generation model must be solved at many points in the computational domain. Solving the model may therefore be necessary even several million times. Therefore, the use of the model in the multiscale context becomes prohibitive, if one considers that the 2176 variables and the computational cost of 13 s per second of simulation must be multiplied by the number of points where the model is placed.

Based on the aforementioned motivations, in this section we show that the computer-implemented method according to the invention allows an approximation of the model to be obtained with a drastically reduced computational cost, thus allowing its use in the context of multiscale entire-heart simulations.

For this purpose, by means of numerical approximation of the model, a series of input-output pairs have been generated, where the input is given by u(t) = ([Ca²⁺]ᵢ(t),SL(t))^{T}, while the output coincides with the active force y(t) = P(t).

More specifically, introduced into the training set are 50 experiments lasting T = 3 s with step input (a first step at t = 0.2 s and a second step at t = 2 s which returns the system to the initial state of equilibrium); 45 oscillating inputs, defined by sinusoids; 60 experiments generated with random inputs.

In this application, because the output consists of just one variable, the function g is established a priori equal to g(x) = x·e₁. In other words, the output P(t) is made to coincide with the first element of the state x(t). Consistently, the first element of x₀ is made to coincide with the output corresponding to the initial state of the model HF, while the other elements of x₀ are placed equal to 0.

The training dataset has been used to define the following first black-box term of the loss function:

$${J}_{d a t a} = \frac{1}{{\sum }_{j = 1}^{{N}_{S}} {\int }_{0}^{{T}_{j}} {\left|{\hat{y}}_{j} \left(t\right)\right|}^{2} d t} {\sum }_{j = 1}^{{N}_{S}} {\int }_{0}^{{T}_{j}} {\left|{\hat{y}}_{j} \left(t\right) - {\tilde{y}}_{j} \left(t\right)\right|}^{2} d t$$

where the discrepancy between output of the reduced model ỹⱼ(t) and output of the model HF ŷⱼ(t) is suitably normalized.

As second physics-based loss term, the following has instead been used:

$${J}_{p h y s} = \frac{{ω}_{e}^{2}}{{N}_{x}} {\left|f \left({x}_{0} , {u}_{0}\right)\right|}^{2} + \frac{{ω}_{c}^{2}}{\left|{J}_{c}\right| \left({N}_{x} - 1\right)} {\sum }_{j ∈ {J}_{c}} {\sum }_{i = 2}^{{N}_{x}} \frac{{\left({x}_{j} \left({T}_{j}\right) ⋅ {e}_{i}\right)}^{2}}{\frac{1}{{T}_{j}} {\int }_{0}^{{T}_{j}} {\left({x}_{j} \left(t\right) ⋅ {e}_{i}\right)}^{2} d t}$$

This function is given by the sum of the two terms.

The first term aims at introducing into the learning process the information that the initial state of the system x₀ is an equilibrium state for the input u₀, given by the calcium concentration and by the elongation of the sarcomere in presystolic conditions.

The purpose of the second term is to inform the artificial neural network f about the fact that for the experiments of the set J_{c} the end state of the reduced model coincides with the initial state.

It should be noticed how both the terms of J_{phys} are suitably normalized, while the weights ωₑ and ωₑ permit balancing the contribution relating to the two terms.

The first term of J_{phys} can be replaced by means of the imposition in strong form of the condition |f(x₀, u₀)|=0. More specifically, the results shown here have been obtained in this way.

By carrying out the training as described above, a reduced model has been obtained with just two internal states Nₓ, showing a relative error on the training dataset of 1.44 × 10-².

As far as the computational cost is concerned, the reduced model has only two variables (instead of the 2176 of the original model), and allows simulating 1 s of physical time in only 1 ms of computational time.

It has in practice been ascertained that the described invention achieves the intended objects.

In particular, the fact is emphasized that the computer-implemented method according to the invention allows the construction of mathematical models for phenomena for which it is difficult to construct computationally efficient approaches.

Furthermore, the computer-implemented method according to the invention enables the construction of mathematical models for phenomena, the poor understanding of which does not allow the construction of a suitable white-box mathematical model solely on the basis of first principles.

Furthermore, the computer-implemented method according to the invention allows for correction of unavoidable errors and uncertainties of the dataset.

1. A computer-implemented method for generation of a mathematical model with reduced computational complexity, said computer-implemented method comprising:
receiving at input a dataset comprising a plurality of input-output pairs relating to a phenomenon under consideration;
receiving at input a plurality of functions (J_{phys,i}) relating to principles (1, ..., N_{P}) governing said phenomenon under consideration ;
determining a first term (J_{data}) starting from said dataset comprising said plurality of input-output pairs;
determining a second term (J_{phys}) starting from said functions (J_{phys,i}) relating to said principles (1, ..., N_{P}); and
generating a mathematical model by means of at least one artificial neural network (f, g) trained on a basis of a loss function obtained starting from said first term (J_{data}) and said second term (J_{phys}).

2. The computer-implemented method according to claim 1, wherein said step of generating a mathematical model comprises training at least one artificial neural network (f, g) on the basis of a loss function composed of the weighted average of said first term (J_{data}) and of said second term (J_{phys}).

3. The computer-implemented method according to claim 1, wherein said plurality of input-output pairs of the dataset is produced by said existing mathematical model.

4. The computer-implemented method according to claim 1, wherein said dataset comprising a plurality of input-output pairs is defined by the following formula:
$$\left({\hat{\text{u}}}_{\text{j}} \left(\text{t}\right) , {\hat{\text{y}}}_{\text{j}} \left(\text{t}\right)\right) , \text{t} ∈ \left[0 , {\text{T}}_{\text{j}}\right] \text{by} \text{j} = 1 , … , {N}_{S}$$
where u(t) is a time-dependent input signal
where y(t) is a time-dependent output signal
where Ns is the number of input-output pairs, and
where Tⱼ represents the duration of the j-th pair.

5. The computer-implemented method according to claim 1, wherein said generated surrogate mathematical model is defined by the following formula:
$$\left\{\begin{matrix}\frac{d x}{d t} = \text{f} \left(x \left(t\right) , u \left(t\right)\right) t ∈ \left(0 , T\right) \\ x \left(0\right) = {x}_{0} \\ \tilde{y} \left(t\right) = \text{g} \left(x \left(t\right)\right) t ∈ \left(0 , T\right)\end{matrix}\right)$$
where f represents said first artificial neural network;
g represents said second artificial neural network;
x(t) is a vector with Nₓ elements, representing the internal state of the system;
u(t) is a time-dependent input signal; and
ỹ(t) is a time-dependent output signal predicted by the surrogate mathematical model.

6. The computer-implemented method according to claim 5, wherein said first artificial neural network (f) and said second artificial neural network (g) are trained on the basis of a loss function composed of the weighted average of said first term (J_{data}) and of said second term (J_{phys}).

7. The computer-implemented method according to claim 1, wherein said first term (J_{data}) is a Euclidean standard distance between the plurality of time-dependent outputs (ŷⱼ(t)) belonging to said dataset and the corresponding outputs (ỹⱼ(t)) predicted by said surrogate model.

8. The computer-implemented method according to claim 7, wherein said first term (J_{data}) is defined by the following formula:
$${J}_{d a t a} = \frac{1}{2} {\sum }_{j = 1}^{{N}_{s}} {\int }_{0}^{{T}_{j}} {\left‖{\hat{y}}_{j} \left(t\right) - {\tilde{y}}_{j} \left(t\right)\right‖}^{2} d t$$
where J_{data} is said first term;
ŷⱼ(t) are said outputs belonging to the dataset;
ỹⱼ(t) are said outputs predicted by the surrogate mathematical model;
Ns is the number of input-output pairs; and
Tⱼ represents the duration of the j-th pair.

9. The computer-implemented method according to claim 1, wherein said second term (J_{phys}) is composed of the sum of said functions (J_{phys,i}).

10. The computer-implemented method according to claim 9, wherein said second term (J_{phys}) is defined by the following formula:
$${J}_{p h y s} = \frac{1}{2} {\sum }_{j = 1}^{{N}_{P}} {J}_{p h y s , i} \left(\text{f} , \text{g}\right)$$
where J_{phys} is said second term;
J_{phys,i} (f, g) represents said functions;
f is said first artificial neural network;
g is said second artificial neural network; and
1, ..., Nₚ represent said principles governing the phenomenon under consideration.

11. The computer-implementd method according to claim 1, wherein said step of generating a mathematical model comprises at least one training step of said artificial neural networks (f, g) carried out according to the following optimization problem:
$$\left({η}^{∗} , {γ}^{∗}\right) = {arg min}_{η , γ} \left({J}_{d a t a} + {J}_{p h y s}\right)$$
where ƞ and γ are vectors that collect the values of the parameters of the two networks (f, g), subject to the constraint given by:
$$\left\{\begin{matrix}\frac{d {x}_{j}}{d t} = f \left({x}_{j} \left(t\right) , {u}_{j} \left(t\right) ; η\right) j = 1 , … , {N}_{S} , t ∈ \left(0 , T\right) \\ {x}_{j} \left(0\right) = {x}_{0} j = 1 , … , {N}_{S} \\ {\tilde{y}}_{j} \left(t\right) = g \left({x}_{j} \left(t\right) ; γ\right) j = 1 , … , {N}_{S} , t ∈ \left(0 , T\right)\end{matrix}\right)$$
.

12. A non-transitory computer readable medium having instructions stored thereon, such that when the instructions are read and executed by one or more processors, said one or more processors is configured to perform the steps of:
receiving at input a dataset comprising a plurality of input-output pairs relating to a phenomenon under consideration;
receiving at input a plurality of functions relating to principles governing said phenomenon under consideration;
determining a first term starting from said dataset comprising said plurality of input-output pairs;
determining a second term starting from said functions relating to said principles; and
generating a mathematical model by means of at least one artificial neural network trained on a basis of a loss function obtained starting from said first term and said second term.
